(19) United States
(12) Patent Application Publication
(10) Pub. No.: US 2018/0216503 A1
(43) Pub. Date: Aug. 2, 2018

(54) TRAVEL STOP FOR PLANETARY GEARS OF AN ELECTRIC PHASER

(71) Applicant: BorgWarner Inc., Auburn Hills, MI (US)

(72) Inventors: Mark M. WIGSTEN, Lansing, NY (US); Daniel BROWN, Freeville, NY (US)

(21) Appl. No.: 15/748,662

(22) PCT Filed: Jul. 25, 2016
(86) PCT No.: PCT/US2016/043814

§ 371 Date: Jan. 30, 2018

Related U.S. Application Data
(60) Provisional application No. 62/198,708, filed on Jul. 30, 2015.

(51) Int. Cl. F01L 1/352; F16H 1/28; F01L 1/348

(52) U.S. Cl. CPC F01L 1/352; F16H 1/28; F01L 2820/032; F01L 2250/02; F01L 1/348

(57) ABSTRACT

An electric phaser for dynamically adjusting the phase of a camshaft relative to a crankshaft with a split ring planetary drive. The split ring planetary drive including: a sun gear driven by a motor, a plurality of planetary gears with stop teeth, a first ring gear driven by the crankshaft, and a second ring gear rotatable with the camshaft. Either the first or second ring gears each include a first and a second stop. When the stop teeth of the planetary gears interacts with the first stop or the second stop on either the first or second ring gears, rotation of the phaser further in the first direction or the second direction towards the first or second stops is halted.

### BACKGROUND OF THE INVENTION

### Field of the Invention

The invention pertains to the field of phasers. More particularly, the invention pertains to travel stops for planetary gears of an electric phaser.

### Description of Related Art

Variable cam timing or “VCT” is a process that refers to controlling and varying, when desirable, the angular relationship (the “phase”) between the drive shaft and one or more camshafts, which control the engine's intake and exhaust valves. In a closed loop VCT system, the system measures the angular displacement, or phase angle, of a camshaft relative to the crankshaft to which it is operatively connected, and then alters the phase angle to adjust various engine characteristics in response to demands for either an increase or a reduction in power. Typically, there is a feedback loop in which the desired values of such engine characteristics are measured against their existing values, and changes are effected inside the engine in response to any variances. To accomplish this, modern automobiles usually have one or more Electronic Control Units (ECU), which constantly analyze data fed into them from various parts of the engine or from other parts of the automobile, such as, for example, exhaust gas sensors, pressure sensors, and temperature sensors. A control signal is then emitted in response to such data. For example, with regard to VCT systems, as changes occur in engine or external conditions, the angular displacement between the camshaft and the crankshaft is adjusted accordingly.

A VCT system includes a cam phasing control device, sometimes referred to as a phaser, control valves, control valve actuators, and control circuitry. An electric phaser (e-phaser) is driven by an electric motor to control and vary the angular relationship between the drive shaft and one or more camshafts. In response to input signals, the electric phaser adjusts the camshaft to either advance or retard engine timing.

These systems have a high ratio gear train and can phase the camshaft relative to the crankshaft by means of a motor spinning at the same speed as the camshaft. As the motor spins faster than the camshaft the phaser will phase the camshaft relative to the crank shaft in one direction and as the motor slows down, the camshaft to crank shaft phase will move in the opposite direction.

In order to change the angular relationship between the drive shaft and one or more camshafts, the travel of the phaser needs to be limited, however stopping one of the rings gears relative to the other can cause the planet gears to over-run slightly, which can bind the planet teeth with the ring gear teeth or pinch the teeth of the planetary gear between the two ring gears. The motor used to drive the sun gear may not always provide enough torque to undo the binding of the planetary ring gear teeth with the ring gears. Furthermore, limiting the travel of the carrier in order to stop the travel of the phaser at specific stops is problematic as well, as the carrier rotates more than once during phaser travel.

### SUMMARY OF THE INVENTION

An electric phaser for dynamically adjusting the phase of a camshaft relative to a crankshaft with a split ring planetary drive is disclosed. The split ring planetary drive comprises: a sun gear driven by a motor, a plurality of planetary gears with stop teeth, a first ring gear driven by the crankshaft, and a second ring gear rotatable with the camshaft. Either the first or second ring gears each include a first and a second stop. When the stop teeth of the planetary gears interacts with the first stop or the second stop on either the first or second ring gears, rotation of the phaser further in the first direction or the second direction towards the first or second stops is halted.

In another embodiment, an electric phaser for dynamically adjusting a rotational relationship of a camshaft of an internal combustion engine with respect to an engine crankshaft is disclosed. The electric phaser comprising: an electric motor; and a split ring or a ring planetary drive. The split ring planetary drive comprising: a carrier driven to rotate; a planetary gear arranged around the carrier comprising a plurality of planetary teeth and at least one stop tooth; a second ring gear driven by a second shaft, the second ring gear comprising a plurality of second ring gear teeth maintaining the second ring gear in meshing engagement with the planetary gear teeth of the planetary gear; a first ring gear rotatable with a first shaft, the first ring gear comprising a plurality of first ring gear teeth maintaining the first ring gear in meshing engagement with the planetary gear teeth of the planetary gear; and a stop on the first ring gear or the second ring gear. When the electric motor drives the carrier at a speed less than a speed of the engine crankshaft, the carrier rotates the planetary gear, which rotates the sprocket ring gear and the camshaft ring gear at different rates, adjusting the rotational relationship between the camshaft and the engine crankshaft until the stop tooth of the planetary gear interacts with the stop, halting rotation of the split ring planetary drive in a first direction and preventing further rotation of the split ring planetary drive in the first direction. When the electric motor drives the carrier at a speed greater than a speed of the engine crankshaft, the carrier rotates the planetary gear, which rotates the sprocket ring gear and the camshaft ring gear at different rates, adjusting the rotational relationship between the camshaft and the engine crankshaft until the stop tooth of the planetary gear interacts with the stop, halting rotation of the split ring planetary drive in a second direction and preventing further rotation of the split ring planetary drive in the second direction.

In another embodiment, an electric phaser for dynamically adjusting a rotational relationship of a camshaft of an internal combustion engine with respect to an engine crankshaft is disclosed. The electric phaser comprising: an electric motor; and a planetary drive. The planetary drive comprising: a carrier driven to rotate; a planetary gear arranged around the carrier comprising a plurality of planetary teeth and at least one stop tooth and coupled to the crankshaft or the camshaft; a ring gear driven by the other of the crankshaft or camshaft, the ring gear comprising a plurality of ring gear teeth maintaining the ring gear in meshing engagement with the planetary gear teeth of the planetary gear; and a stop on the ring gear. When the electric motor drives the carrier at a speed less than a speed of the engine crankshaft, the carrier rotates the planetary gear, which rotates the ring gear at a different rate than the planetary gear, adjusting the rotational relationship between the camshaft and the engine crankshaft until the stop tooth of the planetary gear interacts with the stop, halting rotation of the planetary drive in a first direction and preventing further rotation of the planetary drive in the first direction. When the electric motor drives the carrier at a speed greater than a speed of the engine crankshaft, the carrier rotates the planetary gear, which rotates the ring gear at a different rate than the planetary gear, adjusting the rotational relationship between the camshaft and the engine crankshaft until the stop tooth of the planetary gear interacts with the stop, halting rotation of the planetary drive in a second direction and preventing further rotation of the planetary drive in the second direction.

In another embodiment, a planetary drive for adjusting relative phases of a first shaft and a second shaft is disclosed. The planetary drive comprises: a carrier driven to rotate; a planetary gear arranged around the carrier comprising a plurality of planetary teeth and at least one stop tooth and coupled to the first shaft or the second shaft; a ring gear driven by the other of the first shaft or the second shaft, the ring gear comprising a plurality of ring gear teeth maintaining the ring gear in meshing engagement with the planetary gear teeth of the planetary gear; and a stop on the ring gear. When the stop tooth of the planetary gear interacts with the stop in the first direction, a rotation of the planetary drive is halted in the first direction, preventing further rotation of the split ring planetary drive in the first direction. When the stop tooth of the planetary gear interacts with the stop in a second direction, rotation of the planetary drive is halted in the second direction, opposite the first direction, preventing further rotation of the planetary drive in the second direction.

In another embodiment, a split ring planetary drive for adjusting relative phases of a first shaft and a second shaft is disclosed. The split ring planetary drive comprises: a carrier driven to rotate; a planetary gear arranged around the carrier comprising a plurality of planetary teeth and at least one stop tooth; a second ring gear driven by a second shaft, the second ring gear comprising a plurality of second ring gear teeth maintaining the second ring gear in meshing engagement with the planetary gear teeth of the planetary gear; a first ring gear rotatable with a first shaft, the first ring gear comprising a plurality of first ring gear teeth maintaining the first ring gear in meshing engagement with the planetary gear teeth of the planetary gear; and a stop on the first ring gear or the second ring gear. When the stop tooth of the planetary gear interacts with the stop in the first direction, a rotation of the planetary drive is halted in the first direction, preventing further rotation of the split ring planetary drive in the first direction. When the stop tooth of the planetary gear interacts with the stop in a second direction, rotation of the planetary drive is halted in the second direction, opposite the first direction, preventing further rotation of the planetary drive in the second direction.

In another embodiment, a split ring planetary drive for adjusting relative phases of a first shaft and a second shaft is disclosed. The split ring planetary drive comprising: a carrier driven to rotate; a planetary gear arranged around the carrier comprising a plurality of planetary teeth and at least one stop tooth, the second ring gear comprising a plurality of second ring gear teeth maintaining the second ring gear in meshing engagement with the planetary gear teeth of the planetary gear; a first ring gear rotatable with a first shaft, the first ring gear comprising a plurality of first ring gear teeth maintaining the first ring gear in meshing engagement with the planetary gear teeth of the planetary gear; and a stop on the first ring gear or the second ring gear. When the stop tooth of the planetary gear interacts with the stop in the first direction, a rotation of the planetary drive is halted in the first direction, preventing further rotation of the split gear planetary drive in the first direction. When the stop tooth of the planetary gear interacts with the stop in a second direction, rotation of the planetary drive is halted in the second direction, opposite the first direction, preventing further rotation of the planetary drive in the second direction. The planetary gear may be a shared planetary gear or may be a compound planetary gear.

In another embodiment, a planetary drive for adjusting relative phases of a first shaft and a second shaft is disclosed. The planetary drive comprising: at least one planetary gear having plurality of planetary teeth and at least one stop tooth and coupled to the first shaft or the second shaft through a coupling; a ring gear driven by the other of the first shaft or the second shaft, the ring gear comprising a plurality of ring gear teeth maintaining the ring gear in meshing engagement with the planetary gear teeth of at least a portion of the planetary gear; a stop on the ring gear. When the stop tooth of the planetary gear interacts with the stop in the first direction, a rotation of the planetary drive is halted in the first direction, preventing further rotation of the split ring planetary drive in the first direction and when the stop tooth of the planetary gear interacts with the stop in a second direction, rotation of the planetary drive is halted in the second direction, opposite the first direction, preventing further rotation of the planetary drive in the second direction.

### BRIEF DESCRIPTION OF THE DRAWING

FIG. 1 shows a schematic of an electric phaser with one of the planetary gears contacting a first stop of the ring gear, limiting the travel of the phaser at a first stop position.

FIG. 2 shows a schematic of the electric phaser after a first rotation of the sun gear.

FIG. 3 shows a schematic of the electric phaser after a second rotation of the sun gear.

FIG. 4 shows a schematic of the electric phaser with another one of the planetary gears contacting a second stop of the ring gear, limiting the travel of the phaser at a second stop position.

FIG. 5 shows a top view of a planetary gear with a stop tooth.

FIG. 6 shows a perspective view of a planetary gear with a stop tooth.

FIG. 7 shows a schematic of a path of a point on the planetary gear relative to the ring gear.

FIG. 8 shows a schematic of an electric phaser including a cross-sectional view of the planetary drive system of FIG. 1 along line 8-8.

FIG. 9 shows a schematic of an electric phaser of another embodiment in which rotation of the planet gear is between stop positions.

FIG. 10 shows a schematic of the electric phaser of another embodiment in which the planet gear contacts a stop, limiting the travel of the phaser

FIG. 11 shows a graph of the planet stop path during phasing in the advance direction and the retard direction.

FIG. 12 shows a schematic of stop placement on a planetary system of an alternate embodiment.

FIG. 13 shows a schematic of stop placement on an alternate planetary system of another alternate embodiment.

FIG. 14 shows a schematic of stop placement on another planetary system of another embodiment.

FIG. 15 shows a schematic of planet stop path during phasing, starting and returning to the same point.

### DETAILED DESCRIPTION OF THE INVENTION

An electric phaser dynamically adjusts the rotational relationship of the camshaft of an internal combustion engine with respect to the engine crankshaft using an electrical actuator such as an electric motor. The electric phaser of the present invention includes a planetary drive system driven by an electric motor. The planetary drive system may include a centrally-located sun gear, and a plurality of planet gears engaging the sun gear. The planetary drive system may be a split ring planetary drive system with a sprocket ring gear driven by the engine crankshaft and a camshaft ring gear concentric with the sun gear and connected to the camshaft. In one embodiment a planet carrier may be present to connect the planet gears together. The planet gears are loaded with respect to each other to reduce backlash in the planetary drive system. The electric motor is preferably a brushless DC motor, although it will be understood that other forms of motors such as DC motors with brushes, AC motors or stepping motors can be used.

There is a tooth count difference between the camshaft ring gear and the sprocket ring gear. The camshaft ring gear moves at a slightly different speed than the sprocket ring gear due to the tooth difference when the sun gear rotates at a different speed than the camshaft.

In some embodiments, an electric motor is connected to the sun gear to drive the sun gear in relation to the planet gears. When the electric motor rotates the sun gear at the same speed as the sprocket ring gear, a constant phase position is maintained between the crankshaft and the camshaft. Under these conditions, the planetary gear assembly rotates as a unit with no relative movement between the sun gear and the planet gears or between the planet gears and the ring gears. Adjusting the electric motor speed with respect to the sprocket ring gear/camshaft ring gear/camshaft adjusts the phase of the camshaft with respect to the crankshaft. When the electric motor rotates the sun gear at a speed faster than the speed of the camshaft, the phaser is moved in the retarding direction. When the electric motor rotates the sun gear at a speed slower than the speed of the camshaft, the phaser is moved in the advancing direction.

The sprocket ring gear, the camshaft ring gear, the planet gears, and the sun gear are arranged in a planetary gear drive connection preferably having a high numerical gear ratio to allow accurate phasing angle adjustment with a relatively low driving torque requirement for the electric motor. The sprocket ring gear is preferably driven by the engine crankshaft through a sprocket and an endless loop power transmission chain, and the camshaft ring gear is preferably connected to rotate with the camshaft.

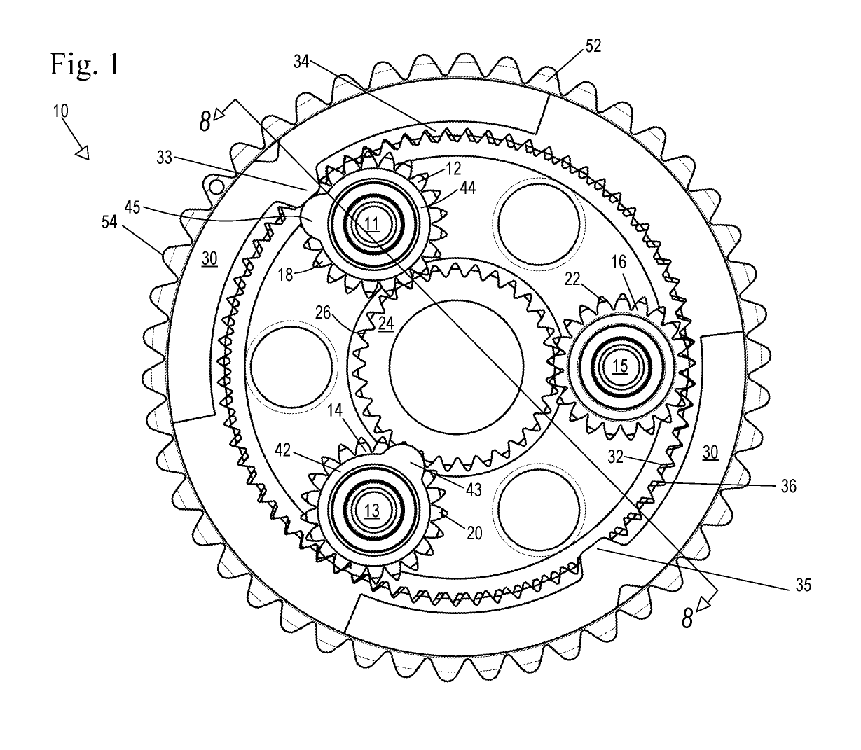

FIGS. 1-4 and 8 show a split ring gear planetary drive 10 which includes planet gears 12, 14, 16 with planet gear teeth 18, 20, 22, a centrally located sun gear 24 with sun gear teeth 26, and a split ring gear including a sprocket ring gear 30 and a camshaft ring gear 32. It should be noted that in FIGS. 1-4, the carrier 38 is not shown.

The ring gears 30, 32 have different numbers of teeth 34, 36, where the difference in the number of teeth is a multiple of the number of planet gears 12, 14, 16. The ring gear teeth 34, 36 have profiles to allow the ring gears 30, 32 to mesh properly with the planet gears 12, 14, 16. Either the sprocket ring gear 30 or the camshaft ring gear 32 has at least two stops 33, 35. The stops 33, 35 are spaced around a circumference of the ring gear and are spaced to define limits of travel for the phaser in a first direction and a second direction.

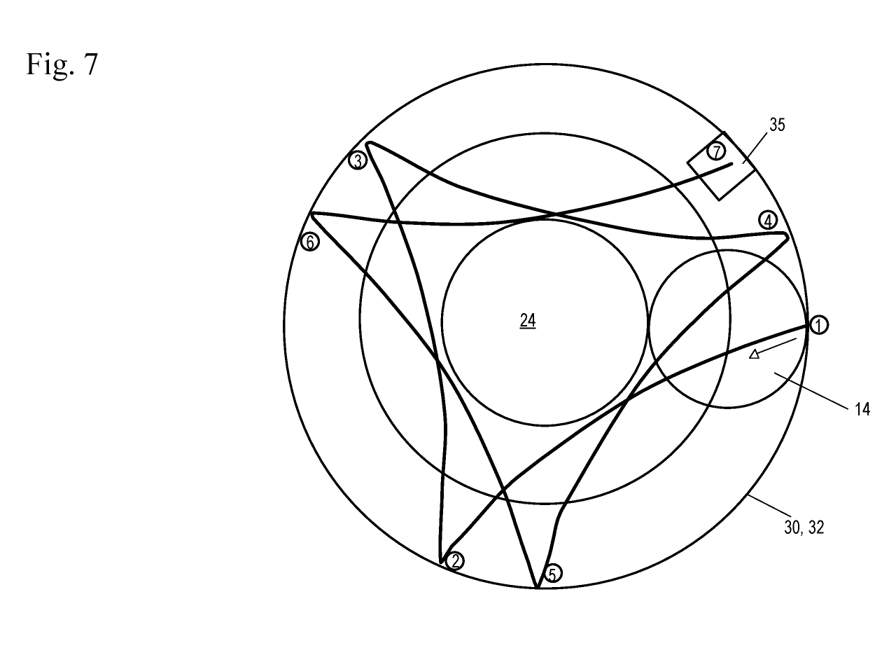

The planetary gears 12, 14, 16 rotate around the sun gear 24 and within the ring gears 30, 32 such that the planetary gears 12, 14, 16 travel along a hypocycloid curves, a curve generated by the trace of a fixed point on a small circle (planetary gear) that rolls within a larger circle (ring gear). The path in which one of the planetary gears 14 travels within the ring gears 30, 32 is shown in FIG. 7. A tooth of the planetary gear 14 engages at place 1, travels within the ring gear 30, 32, and around the sun gear 24, such that the same tooth engages the ring gear at place 2, place 3, place 4. The path of the planetary gear 14 eventually hits stop 35 on the ring gear 30, 32. As shown in FIG. 7, the planetary gear 14 may make several revolutions within the ring gear prior to the planetary gear 14 engaging the stop on the ring gear 30, 32. After engaging the stop, the planetary gear 14 can no longer rotate any further in the same direction, and can only turn in the opposite direction. Thus, the phaser is held in a position representing a maximum advanced or retarded condition.

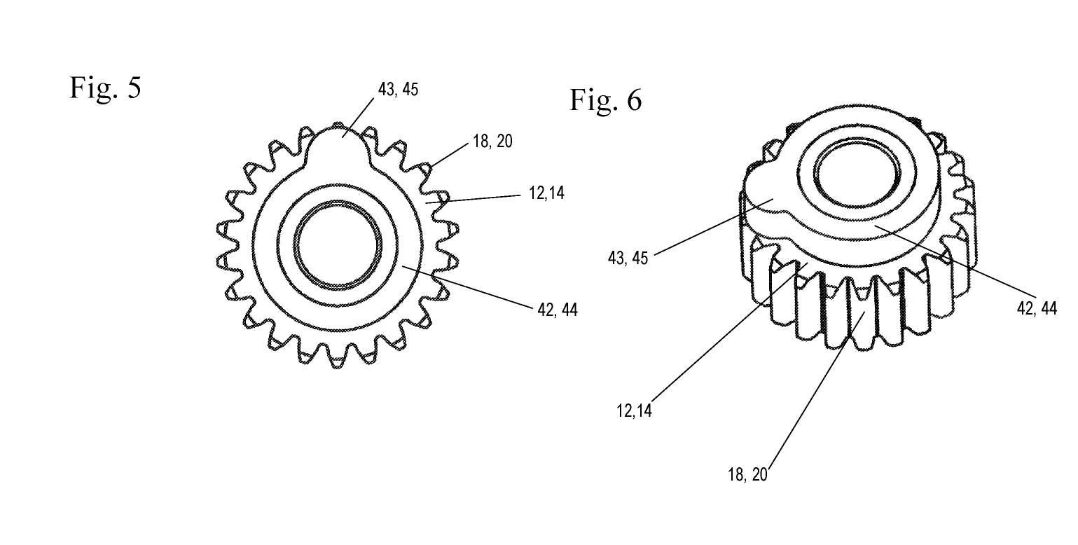

At least two of the planetary gears 12, 14 have stop teeth 43, 45 which are mounted to a face of the gears 12, 14 as shown in FIGS. 5-6. When the stop teeth 43, 45 engage the stops 33, 35 on either the sprocket ring gear 30 or the camshaft ring gear 32, motion of the split ring gear planetary drive 10 of the phaser is halted. The planetary gears 12, 14, 16 are maintained in a fixed relationship to each other by a planetary carrier 38. The planet carrier 38 receives pins 11, 13, 15 which couple the planetary gears 12, 14, 16 to the planet carrier 38. Planetary gears 12, 14, 16 rotate on pins 11, 13, 15.

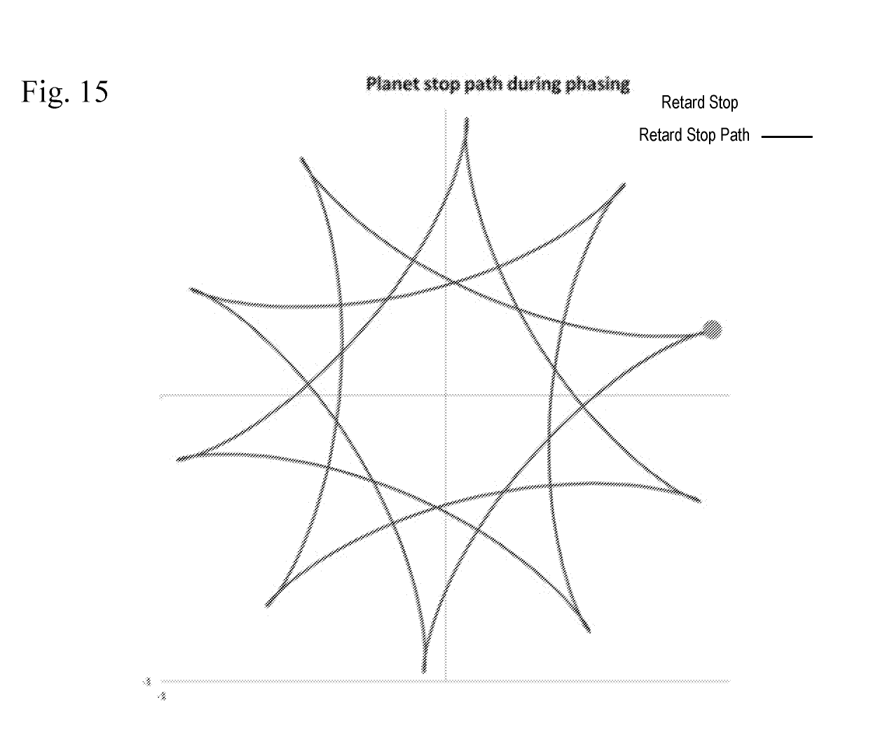

While two planetary gears 12, 14 are shown as each have a stop tooth 43, 45, only one planetary gear may contain a stop tooth where the stop tooth hits the stops on either the sprocket ring gear 30 or the camshaft ring gear 32. A single stop on either the sprocket ring gear 30 or camshaft ring gear 32 could also be used. In FIG. 15, the path of one stop tooth 43 on one planet gear 12 is shown such that it engages with a single stop on either the sprocket ring gear 30 or camshaft ring gear 32, thus defining the limits of travel in a first direction and a second direction.

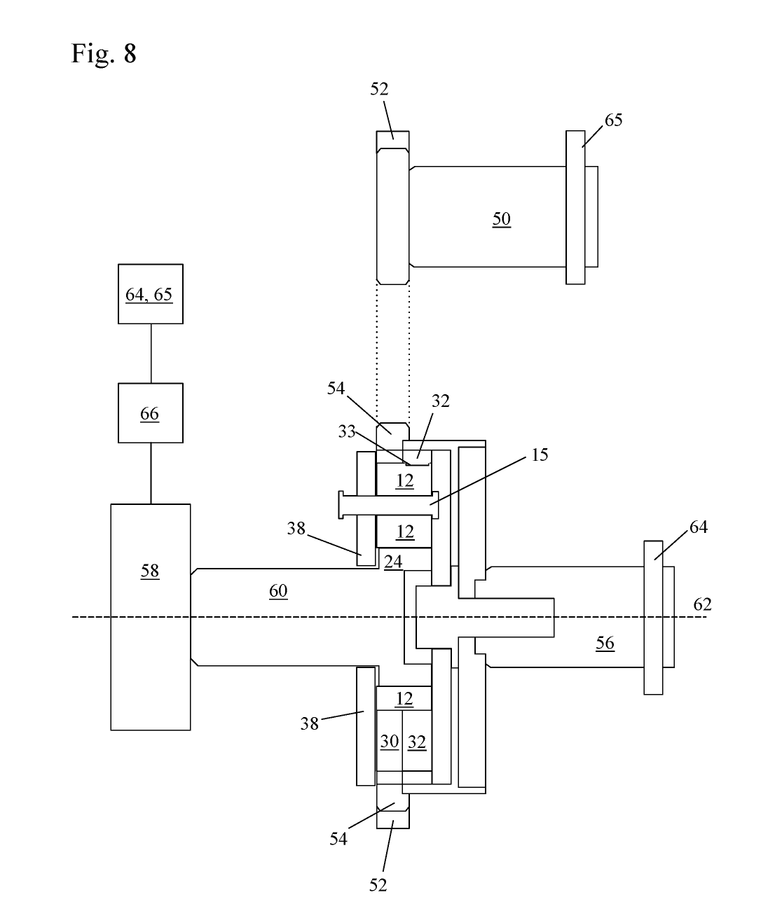

Referring to FIG. 8, an engine crankshaft 50 is rotationally engaged through a timing chain 52 to the sprocket ring gear 30 through a sprocket 54, and the engine camshaft 56 is rotationally engaged to the camshaft ring gear 32. An electric motor 58 is rotationally engaged with the sun gear 24 by way of an output shaft 60. When the sun gear 24 is rotated by the electric motor 58 around its axis 62 at the same speed as either of the ring gears 30, 32, since both ring gears 30, 32 rotate in unison, a constant cam phase position is maintained. When the sun gear 24 is driven at a different speed from the ring gears 30, 32 by the electric motor 58, a slightly different speed of one ring gear to the other ring gear causes a cam phase shift function. In this way, a very high numerical ratio is obtained and the camshaft 56 is phased either plus or minus from the nominal rotational relationship of the crankshaft 50 to the camshaft 56.

The phaser is preferably used to dynamically adjust the rotational relationship of the camshaft 56 to the engine crankshaft 50 either to improve the fuel efficiency of the engine or to provide greater power under load or acceleration. Sensors 64, 65, preferably one on the crankshaft 50 and one on the camshaft 56 are preferably used as feedback to a motor controller 66 to measure the current position of the camshaft 56 relative to the crankshaft 50 to determine what adjustment, if any, is desired at any point in time to achieve optimal engine efficiency.

FIG. 1 shows the electric phaser with one of the planetary gears 12 contacting a first stop 33 of the sprocket ring gear 30, limiting the travel of the phaser in a first direction to a first stop position. In this position, the engagement of a first stop tooth 45 on the planetary gear 12 with a first stop 33 on the sprocket ring gear 30 halts any further rotation of the sprocket ring gear 30, planetary gears 12, 14 16 and the sun gear 24. The second stop tooth 43 on another of planetary gears 14 is not engaged with sprocket ring gear 30.

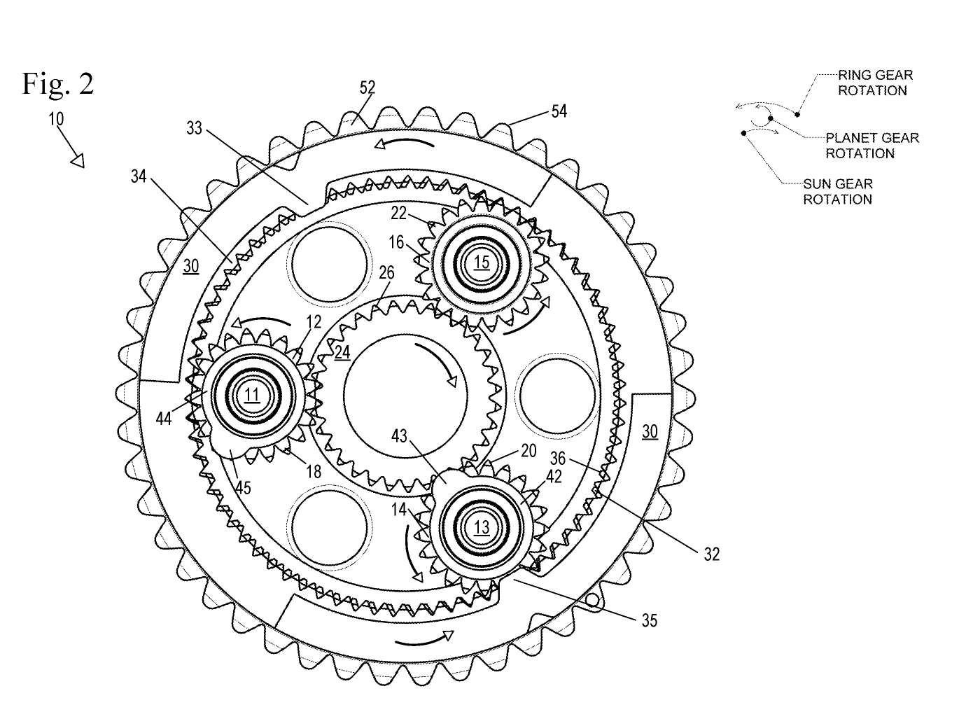

FIG. 2 shows a schematic of the electric phaser after a first rotation of the sun gear. The ring gears 30, 32 rotate in a counterclockwise direction, the sun gear 24 rotates clockwise, and the planetary gears 12, 14, 16 rotate in the counterclockwise direction. Neither of the stop teeth of the planetary gears 12, 14 engage the first and second stops 33, 35 of the sprocket ring gear 30. The rotation of the planetary gears 12, 14 is such that the stop teeth 43, 45 of the planetary gears 12, 14 do not align with or engage the stops 33, 35 on the sprocket ring gear 30 until the phaser travel limit is reached. In this Figure, the sun gear may be driven by the motor 58 at the same speed as the ring gears 30, 32, maintaining a phase position or alternatively, the sun gear may be driven by the motor 58 to rotate at a different speed than the ring gears 30, 32 advancing or retarding the phaser, altering the rotational relationship between the camshaft and the engine crankshaft.

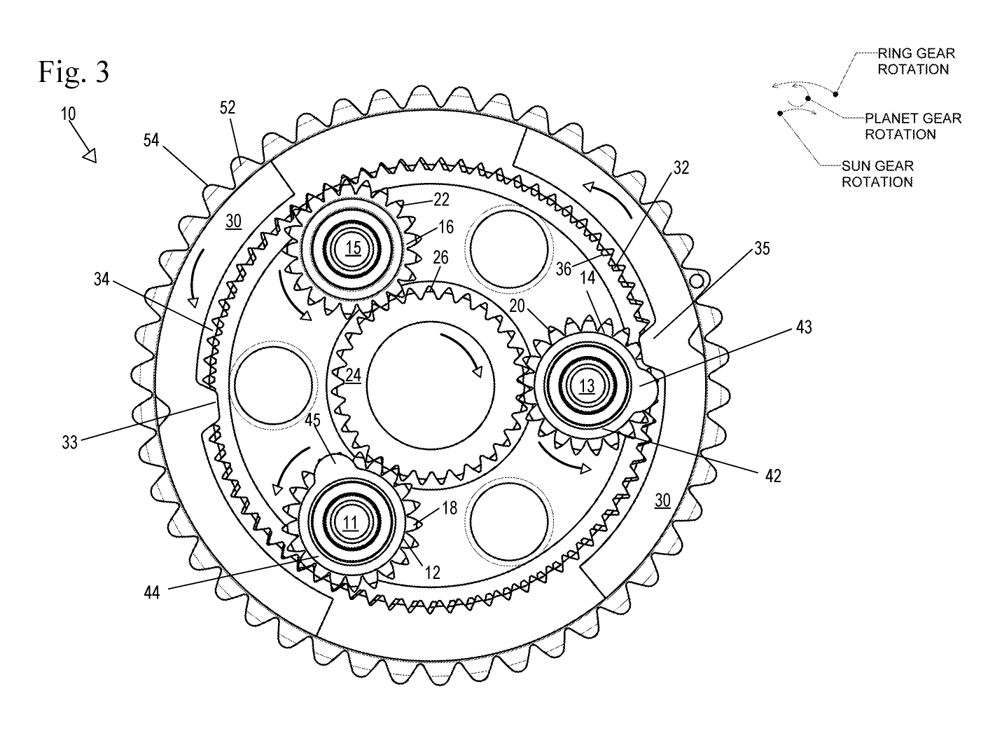

FIG. 3 shows a schematic of the electric phaser after a second rotation of the sun gear. Similar to FIG. 2, neither of the stop teeth of the planetary gears 12, 14 engage the first and second stops 33, 35 of the sprocket ring gear 30. The rotation of the ring gear 30 is such that the stop tooth 43 of the planetary gear 14 will continue to rotate and miss engaging with the stop 35 of the sprocket ring gear 30. The stop tooth 45 does not engage with either of the stops 33, 35. In this Figure, the sun gear may be driven by the motor 58 at the same speed as the ring gears 30, 32, maintaining a phase position or alternatively, the sun gear may be driven by the motor 58 to rotate at a different speed than the ring gears 30, 32 advancing or retarding the phaser, altering the rotational relationship between the camshaft and the engine crankshaft.

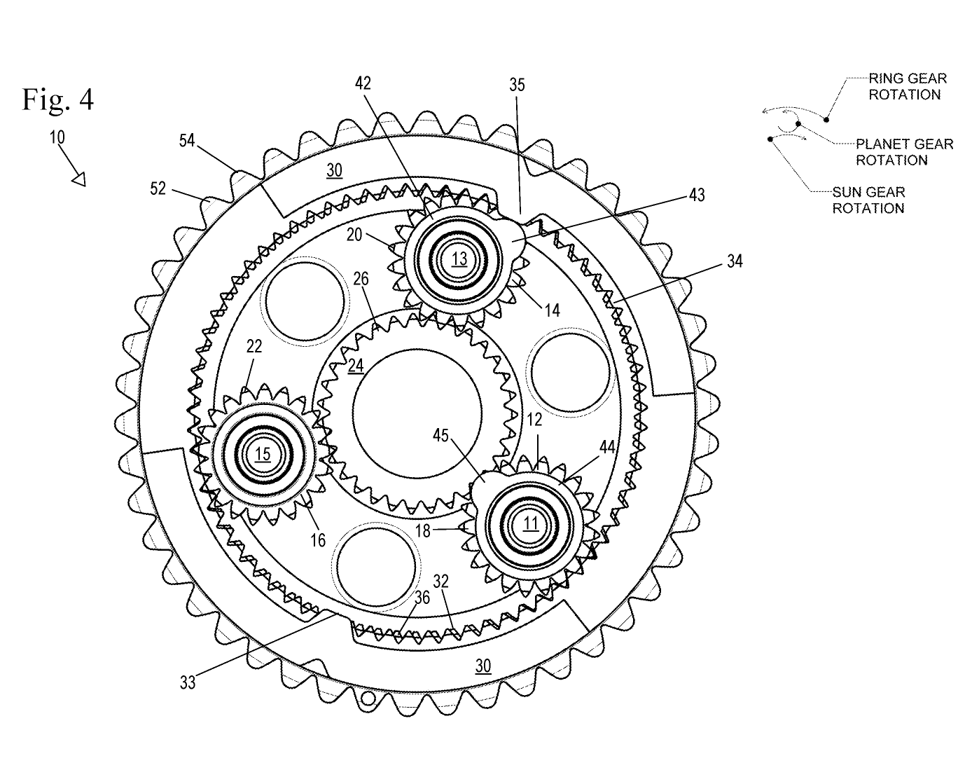

FIG. 4 shows a schematic of the electric phaser with another one of the planetary gears contacting a second stop of the ring gear, limiting the travel of the phaser in a second direction to a second stop position. In this position, the engagement of a second stop tooth 43 on the planetary gear 14 with a second stop 35 on the sprocket ring gear 30 halts any further rotation of the sprocket ring gear 30, planetary gears 12, 14 16 and the sun gear 24. The first stop tooth 45 on another of planetary gears 12 is not engaged with sprocket ring gear 30. It should be noted that in order to move the planetary gear 14 with the second stop tooth 43 off of or away from the second stop 35, the planetary gears must rotate clockwise, the ring gears must rotate clockwise and the sun gear rotates counterclockwise, opposite the direction of rotation of the planetary drive to reach the second stop in the second direction.

In another embodiment, an electric phaser dynamically adjusts the rotational relationship of the camshaft of an internal combustion engine with respect to the engine crankshaft using an electrical actuator such as an electric motor. The electric phaser of the present invention includes a planetary drive system driven by an electric motor. The planetary drive system may include a carrier and at least one planetary gear. The carrier may be an eccentric shaft which is driven by the electric motor.

The planetary drive system may be a split ring planetary drive system with a sprocket ring gear driven by the engine crankshaft and a camshaft ring gear concentric with the carrier connected to the camshaft.

Alternatively, the planetary drive system may have a single ring gear connected to the engine crankshaft or camshaft and a planetary gear connected to the other of the engine crankshaft or camshaft via a coupling. The coupling may be an Oldham coupling or a flexible couple or any coupling known in the art to couple misaligned axes.

The tooth count difference between the planetary gear and ring gear(s) in this case may be a small number, and may be one.

When the electric motor rotates the eccentric shaft, and thus the planet carrier at the same speed as the ring gear or sprocket ring gear, a constant phase position is maintained between the crankshaft and the camshaft. Under these conditions, the planetary gear assembly rotates as a unit with no relative movement between the planet carrier and the planetary gear or between the planetary gear and the ring gear(s). Adjusting the electric motor speed with respect to the sprocket ring gear/camshaft ring gear/ring gear/camshaft adjusts the phase of the camshaft with respect to the crankshaft. When the electric motor rotates the eccentric shaft and thus the planet carrier at a speed faster than the speed of the camshaft, the phaser is moved in the direction indicated by the sign of the gear ration between the motor and the camshaft with respect to the sprocket ring gear. A positive gear ratio advances the phaser and a negative gear ration retards the phaser.

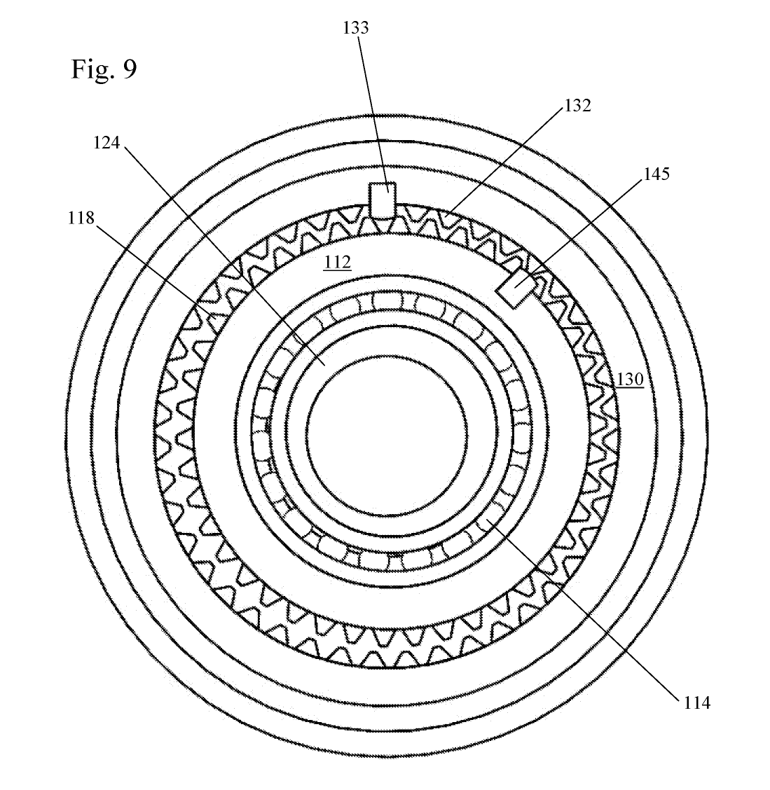

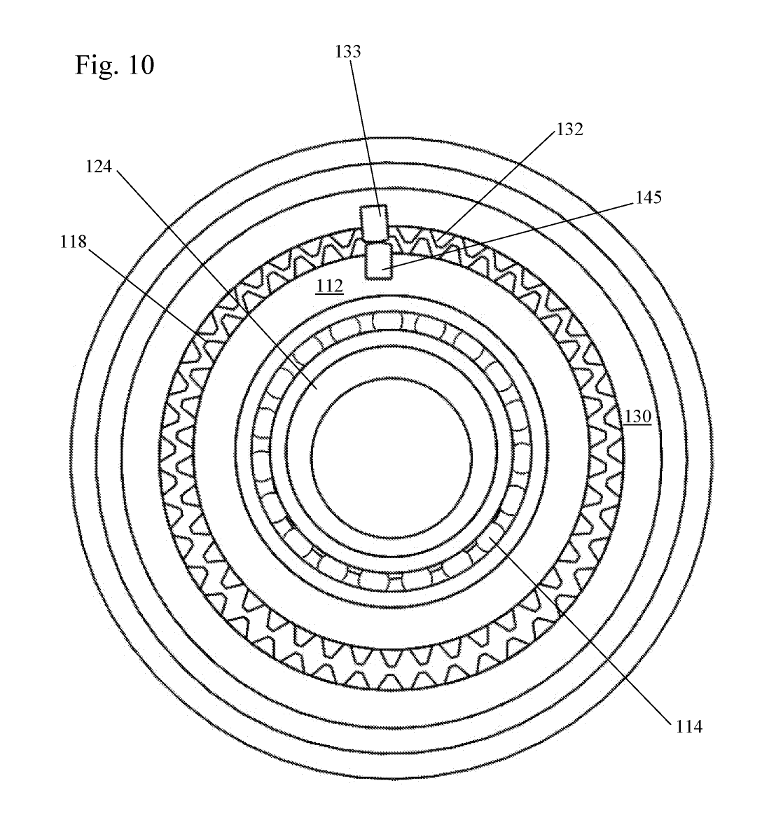

FIGS. 9-10 show a planetary drive 100 of another embodiment.

In this embodiment, a sun gear is not present. A planetary gear 112 has planetary gear teeth 118 and a stop tooth 145. The planetary gear 112 may be directly connected to either the camshaft or the engine crankshaft via coupling (not shown). The planetary gear 112 is mounted to a carrier 124, which may be an eccentric shaft. Bearings 114 may be present between the planetary gear 112 and the carrier 124 allowing the planetary gear 112 to rotate about the carrier 124.

The planetary gear 118 and carrier 124 are received by a ring gear 130 connected to the other of the camshaft or the engine crankshaft. The ring gear 130 has ring gear teeth 132 which mesh with planetary gear teeth 118 as the planetary gear 112 rotates about the carrier 124. It should be noted that the planetary gear teeth 118 mesh with only a portion of the ring gear teeth 130 at one time.

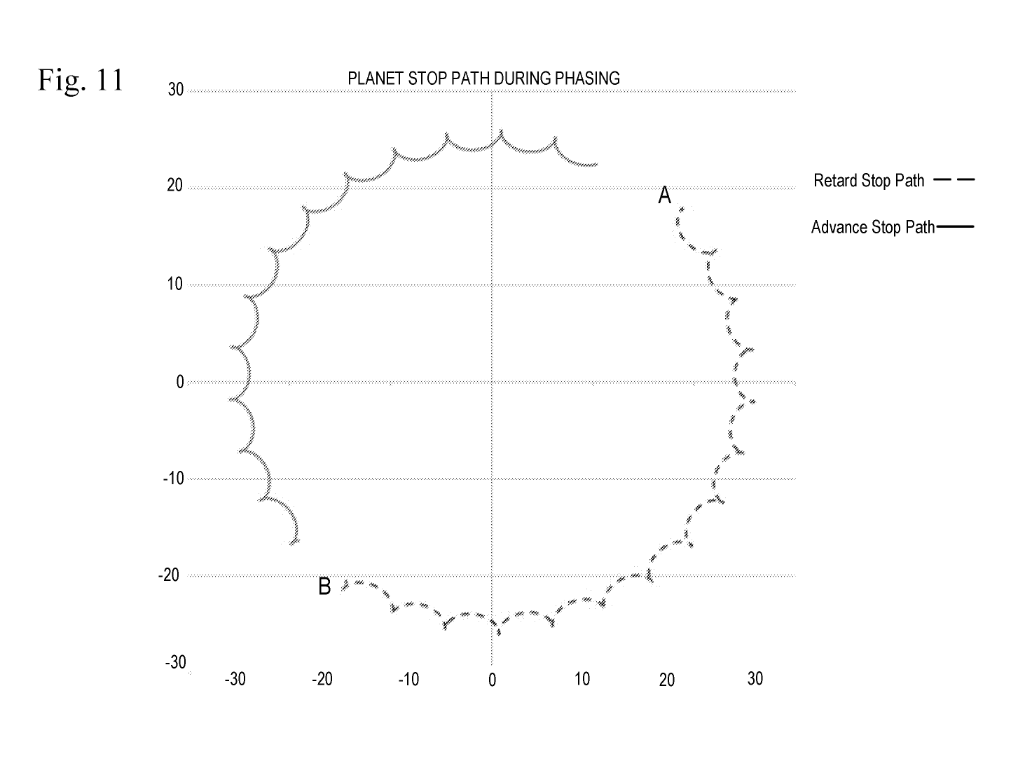

The planetary gear 112 rotates around the planet carrier 124 and within the ring gear 130 such that the planetary gear 112 travels along a hypocycloid curve, a curve generated by the trace of a fixed point on a small circle (planetary gear) that rolls within a larger circle (ring gear). The path in which the stop tooth 145 travels within the ring gear during an advance path and retard path is shown in the graph of FIG. 11. The advance path is indicated by the solid line and the retard path is indicated by the dashed line.

While one only ring gear 130 is shown, it is within the scope of the invention to have a split ring gear which includes a camshaft ring gear with a first set of teeth and a sprocket ring gear with a different set of teeth. The sprocket ring gear is preferably driven by the engine crankshaft through a sprocket and an endless loop power transmission chain, and the camshaft ring gear is preferably connected to rotate with the camshaft. The planetary gear 112 would be mounted to the motor driven carrier.

While only one planetary gear 112 is shown, additional planetary gears may be present. For example, the planetary gear may be a compound planet with different gear teeth, diameter or number of teeth sharing a common rotational axis and fixed to one another.

It should be noted that in FIGS. 9-10, the path of motion of the stop affixed to the planetary gear as viewed from a stationary outer ring.

FIG. 10 shows the stop tooth 145 of the planetary gear 112 approaching a stop position to limit the travel in a retard direction. The stop tooth 145 of the planetary gear 112 will engage with the stop 133 of the ring gear 130 as the planetary gear 112 rotates in the counterclockwise direction, halting any further rotation of the ring gear 130, planetary gear 112 and carrier 124. Rotation of planetary gear 112 then must proceed in the opposite, clockwise direction.

FIG. 9 shows a stop tooth 145 of the planetary gear 112 passing the stop 133 of the ring gear 130. Assuming that the planetary gear 112 is not rotating in an advanced path, the planetary gear 112 rotates in clockwise direction, the carrier 124 rotates in a counterclockwise direction, and the ring gear 130 rotates in a clockwise direction. The stop tooth 145 of the planetary gear 112 does not engage the stop 133 of the ring gear 130. The rotation of the planetary gear 112 is such that the stop tooth 145 of the planetary gear 112 does not align with or engage the stop 133 on the ring gear 130 until the phaser travel limit is reached. In this Figure, the carrier 124 may be driven by a motor (not shown) at the same speed as the ring gear 130, maintaining a phase position or alternatively, the carrier may be driven by the motor (not shown) to rotate at a different speed than the ring gear 130 advancing or retarding the phaser, altering the rotational relationship between the camshaft and the engine crankshaft. If the carrier is rotating at a different speed than the ring gear 130 so as to retard the phaser, the stop tooth 145 of the planetary gear 112 will engage the stop 133 of the ring gear 130 at the limit of travel in the retard direction.

While only one stop is shown on a ring gear, more than one stop may be present on the ring gear or ring gears as shown in FIGS. 1-3 and applied to the single planetary gear mounted to a carrier which may be an eccentric shaft.

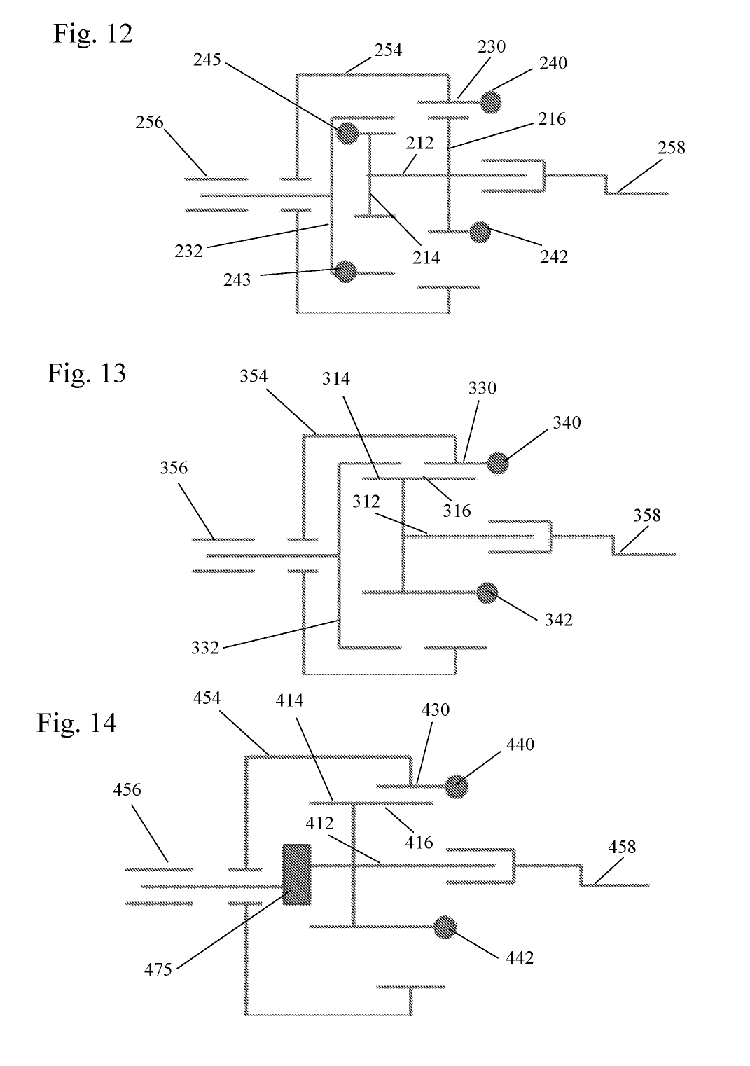

FIG. 12 shows a schematic of stop placement on a planetary system of an alternate embodiment. The planetary system of the alternate embodiment includes at least one compound planet 212. A compound planet is a planet that may have a first portion and a second portion which differ by gear teeth, diameter or number of teeth sharing a common rotational axis and fixed to one another. The compound planet 212 is comprised of a first portion 214 with a first set of teeth and a first stop 245 and a second portion 216 with a second set of teeth with a second stop 242. The compound planet 212 is mounted to a carrier 258 driven by a motor (not shown). Surrounding the second portion 216 of the compound planet 212 is a sprocket ring gear 230 connected to a crankshaft or second shaft 254. Surrounding the first portion 214 of the compound planet 212 is a camshaft ring gear 232. The camshaft ring gear 232 is coupled to the camshaft or first shaft 256.

The ring gears 230, 232 have different numbers of teeth with profiles to allow the ring gears 230, 232 to mesh properly with the first and second portions 214, 216 of the compound planet gear 212.

While the stops 242, 245, 240, 243 are shown between the compound planet 212 and both the cam ring gear 232 and the sprocket ring gear 230, the stops may both be present on the cam ring gear or the sprocket ring gear. The stops 240, 242 are spaced around a circumference of the ring gears and are spaced to define limits of travel for the phaser in a first direction and a second direction.

The first portion 214 and the second portion 216 of the compound planetary gear 212 are driven by the carrier 258 to travel along a hypocycloid curves, a curve generated by the trace of a fixed point on a small circle (planetary gear) that rolls within a larger circle (ring gear) as shown in FIG. 11. As shown in FIG. 11, the starting point and the end are the same. A planet stop path, indicated by the dashed line of FIG. 11 shows the travel of the compound planetary gear 212 which stops at position B in a first direction and stops at position A in a second direction.

When the motor drives the carrier 258 to rotate at a different speed than the ring gears 230, 232, a slightly different speed of one ring gear to the other ring gear causes a cam phase shift function. In this way, a very high numerical ratio may be obtained and the camshaft 256 is phased either advanced or retarded from the nominal rotational relationship of the crankshaft 254 to the camshaft 256.

FIG. 13 shows a schematic of stop placement on an alternate planetary system of another alternate embodiment.

The planetary system of the alternate embodiment includes at least one shared planet 312. A first portion 316 of the shared planet 312 interfaces with sprocket ring gear 330 and a second portion 314 of the same planet 312 interfaces with the camshaft ring gear 332. A first stop 342 is located on the first portion 316 of the shared planet 312 that interfaces with the sprocket ring gear 330. A second stop 340 is located on the sprocket ring gear 332. The shared planet 312 is mounted to a carrier 358 driven by a motor (not shown). Surrounding the second portion 316 of the shared planet 312 is the sprocket ring gear 330 connected to a crankshaft or second shaft 354. Surrounding the first portion 314 of the shared planet 312 is a camshaft ring gear 332. The camshaft ring gear 332 is coupled to the camshaft or first shaft 356.

The ring gears 330, 332 have different numbers of teeth with profiles to allow the ring gears 330, 332 to mesh properly with the first and second portions 314, 316 of the shared planet gear 312.

The stops 340, 324 are spaced around a circumference of the sprocket ring gear 330 and the stop 342 on the shared planetary gear 312 and are spaced to define limits of travel for the phaser in a first direction and a second direction.

The first portion 314 and the second portion 316 of the shared planetary gear 312 are driven by the carrier 358 to travel along a hypocycloid curves, a curve generated by the trace of a fixed point on a small circle (planetary gear) that rolls within a larger circle (ring gear) as shown in FIG. 11. A planet stop path, indicated by the dashed line of FIG. 11 shows the travel of the shared planetary gear 312 which stops in position A in a first direction and position B in a second direction.

When the motor drives the carrier 358 to rotate at a different speed than the ring gears 330, 332, a slightly different speed of one ring gear to the other ring gear causes a cam phase shift function. In this way, a very high numerical ratio may be obtained and the camshaft 356 is phased either advanced or retarded from the nominal rotational relationship of the crankshaft 354 to the camshaft 356.

FIG. 14 shows a schematic of stop placement on another planetary system of another embodiment.

The planetary system of the alternate embodiment includes at least one planet 412. A first portion 416 of the planet 412 interfaces with a ring gear 430. Since a single ring gear is present, a coupling 475 couples the camshaft to the planet 412. The coupling 475 may be a universal joint, Oldham coupling, a flexible coupling or other coupling known to join misaligned axes.

A first stop 442 is located on the first portion 416 of the planet 412 that interfaces with the ring gear 430. A second stop 440 is located on the ring gear 430. The planet 412 is mounted to a carrier 458 driven by a motor (not shown). The stop 440 is spaced around a circumference of the ring gear 430 and the stop 442 on the planetary gear 412 are spaced to define limits of travel for the phaser in a first direction and a second direction.

The first portion 416 of the planetary gear 412 is driven by the carrier 458 to travel along a hypocycloid curves, a curve generated by the trace of a fixed point on a small circle (planetary gear) that rolls within a larger circle (ring gear) as shown in FIG. 11. A planet stop path, indicated by the dashed line of FIG. 11 shows the travel of the planetary gear 412 which stops in position A in a first direction and position B in a second direction.

When the motor drives the carrier 458 to rotate at a different speed than the ring gear 430, a slightly different speed of the ring gear 430 connected to one shaft and the other shaft coupled to the shared planetary gear 412 causes a cam phase shift function. In this way, a very high numerical ratio may be obtained and the camshaft 456 is phased advanced or retarded from the nominal rotational relationship of the crankshaft 454 to the camshaft 456.

Accordingly, it is to be understood that the embodiments of the invention herein described are merely illustrative of the application of the principles of the invention. Reference herein to details of the illustrated embodiments is not intended to limit the scope of the claims, which themselves recite those features regarded as essential to the invention.

What is claimed is:

1. A split ring planetary drive for adjusting relative phases of a first shaft and a second shaft, comprising:
a sun gear driven to rotate around a sun axis, the sun gear comprising a plurality of sun gear teeth;
a plurality of planetary gears arranged around the sun gear, each planetary gear comprising a plurality of planetary teeth maintaining the planetary gear in meshing engagement with the sun gear teeth, wherein at least one of planetary gear has at least one stop tooth;
a second ring gear driven by a second shaft, the second ring gear comprising a plurality of second ring gear teeth maintaining the second ring gear in meshing engagement with the planetary gear teeth of each of the planetary gears;
a first ring gear rotatable with a first shaft, the first ring gear comprising a plurality of first ring gear teeth maintaining the first ring gear in meshing engagement with the planetary gear teeth of each of the planetary gears; and
at least a first stop on the second ring gear or the first ring gear;
wherein when the at least one stop tooth of the at least one of the planetary gears interacts with the at least first stop on the second ring gear or the first ring gear in a first direction, rotation of the split ring planetary drive is halted in the first direction, preventing further rotation of the split ring planetary drive in the first direction;
wherein when the at least one stop tooth of the at least one planetary gears interacts with the at least first stop on the second ring gear or the first ring gear in the second direction, rotation of the split gear planetary drive is halted in the second direction, opposite the first direction, preventing further rotation of the split ring planetary drive in the second direction.

2. The split ring planetary drive of claim 1, further comprising a planet carrier rotatable with the plurality of planetary gears and connected to the planetary gears through pins.

3. The split ring planetary drive of claim 1, wherein the first shaft is a camshaft and the second shaft is a crankshaft.

4. An electric phaser for dynamically adjusting a rotational relationship of a camshaft of an internal combustion engine with respect to an engine crankshaft, the electric phaser comprising:
an electric motor; and
a split ring planetary drive comprising:
a sun gear coupled to the electric motor for rotation around a sun axis by the electric motor, the sun gear comprising a plurality of sun gear teeth;
a plurality of planetary gears arranged around the sun gear, each planetary gear comprising a plurality of planetary teeth maintaining the planetary gear in meshing engagement with the sun gear teeth, and rotatable about a pin;
a sprocket ring gear driven by the engine crankshaft, the sprocket ring gear comprising a plurality of sprocket ring gear teeth maintaining the sprocket ring gear in meshing engagement with the planetary gear teeth of each of the planetary gears;
a camshaft ring gear rotatable with the camshaft, the camshaft ring gear comprising a plurality of camshaft ring gear teeth maintaining the camshaft ring gear in meshing engagement with the planetary gear teeth of each of the planetary gears;
a first stop on the sprocket ring gear or the camshaft ring gear; and
a second stop on the sprocket ring gear or the camshaft ring gear;
wherein when the electric motor drives the sun gear at a speed less than a speed of the engine crankshaft, the sun gear rotates the plurality of planetary gears, which rotates the sprocket ring gear and the camshaft ring gear at different rates, adjusting the rotational relationship between the camshaft and the engine crankshaft until the stop tooth of one of the planetary gears interacts with the first stop, halting rotation of the split ring planetary drive in a first direction and preventing further rotation of the split ring planetary drive in the first direction;
wherein when the electric motor drives the sun gear at a speed greater than a speed of the engine crankshaft, the sun gear rotates the plurality of planetary gears, which rotates the sprocket ring gear and the camshaft ring gear at different rates, adjusting the rotational relationship between the camshaft and the engine crankshaft until the stop tooth of one of the planetary gears interacts with the second stop, halting rotation of the split ring planetary drive in a second direction and preventing further rotation of the split ring planetary drive in the second direction.

5. The electric phaser of claim 4, wherein a total number of camshaft ring gear teeth differs from a total number of sprocket ring gear teeth.

6. The electric phaser of claim 4, further comprising a planet carrier rotatable with the plurality of planetary gears and connected to the planetary gears through pins.

7. The electric phase of claim 4, wherein the rotational relationship is a phase angle between the camshaft and the engine crankshaft.

8. A split ring planetary drive for adjusting relative phases of a first shaft and a second shaft, comprising:
a sun gear driven to rotate around a sun axis, the sun gear comprising a plurality of sun gear teeth;
a plurality of planetary gears arranged around the sun gear, each planetary gear comprising a plurality of planetary teeth maintaining the planetary gear in meshing engagement with the sun gear teeth; wherein at least two of planetary gears each have a stop tooth;
a second ring gear driven by the second shaft, the second ring gear comprising a plurality of second ring gear teeth maintaining the second ring gear in meshing engagement with the planetary gear teeth of each of the planetary gears;
a first ring gear rotatable with the first shaft, the first ring gear comprising a plurality of first ring gear teeth maintaining the first ring gear in meshing engagement with the planetary gear teeth of each of the planetary gears;
a first stop on the second ring gear or the first ring gear; and
a second stop on the second ring gear or the first ring gear;
wherein when the stop tooth of one of the planetary gears interacts with the first stop, rotation of the split gear planetary drive is halted in a first direction, preventing further rotation of the split ring planetary drive in the first direction;
wherein when the stop tooth of the other of planetary gears interacts with the second stop, rotation of the split ring planetary drive is halted in a second direction, opposite the first direction, preventing further rotation of the split ring planetary drive in the second direction.

9. The split ring planetary drive of claim 8, wherein the first stop and second stop are on the second ring gear.

10. The split ring planetary drive of claim 8, wherein the first stop and the second stop are on the first ring gear.

11. A split ring planetary drive for adjusting relative phases of a first shaft and a second shaft, comprising:
a carrier driven to rotate;
a planetary gear coupled to the first shaft or the second shaft, arranged around the carrier comprising a plurality of planetary teeth and at least one stop tooth;
a second ring gear driven by the second shaft, the second ring gear comprising a plurality of second ring gear teeth maintaining the second ring gear in meshing engagement with the planetary gear teeth of the planetary gear;
a first ring gear rotatable with the first shaft, the first ring gear comprising a plurality of first ring gear teeth maintaining the first ring gear in meshing engagement with the planetary gear teeth of the planetary gear; and
at least a first stop on the first ring gear or the second ring gear;
wherein when the at least one stop tooth of the planetary gear interacts with the at least first stop on the first ring or the second ring gear in the first direction, a rotation of the planetary drive is halted in the first direction, preventing further rotation of the split ring planetary drive in the first direction;
wherein when the at least one stop tooth of the planetary gear interacts with the at least first stop on the first ring gear or the second ring gear in a second direction, rotation of the split ring planetary drive is halted in the second direction, opposite the first direction, preventing further rotation of the planetary drive in the second direction.

12. The split ring planetary drive of claim 11, wherein the carrier is an eccentric shaft.

13. A split ring planetary drive for adjusting relative phases of a first shaft and a second shaft, comprising:
an input shaft;
an electric motor driving said input shaft;
at least one planetary gear comprising a plurality of planetary teeth and a stop tooth;
a second ring gear driven by the second shaft, the second ring gear comprising a plurality of second ring gear teeth maintaining the second ring gear in meshing engagement with the planetary gear teeth of the planetary gear;
a first ring gear rotatable with the first shaft, the first ring gear comprising a plurality of first ring gear teeth maintaining the first ring gear in meshing engagement with the planetary gear teeth of the planetary gear; and
a stop on the first ring gear or the second ring gear;
wherein when the stop tooth of a planetary gear interacts with the stop on the first ring gear or the second ring gear in the first direction, a rotation of the split ring planetary drive is halted in the first direction, preventing further rotation of the split ring planetary drive in the first direction;
wherein when the stop tooth of a planetary gear interacts with the stop on the first ring gear or the second ring in a second direction, rotation of the planetary drive is halted in the second direction, opposite the first direction, preventing further rotation of the planetary drive in the second direction.

14. The planetary drive of claim 13, wherein the at least one planetary gear is a compound planetary gear.

15. A planetary drive for adjusting relative phases of a first shaft and a second shaft, comprising:
a carrier driven to rotate;
a planetary gear arranged around the carrier comprising a plurality of planetary teeth and at least one stop tooth and coupled to the first shaft or the second shaft;
a ring gear driven by the other of the first shaft or the second shaft, the ring gear comprising a plurality of ring gear teeth maintaining the ring gear in meshing engagement with the planetary gear teeth of the planetary gear;
at least one stop on the ring gear;
wherein when the stop tooth of the planetary gear interacts a stop in the first direction, a rotation of the planetary drive is halted in the first direction, preventing further rotation of the planetary drive in the first direction;
wherein when the stop tooth of the planetary gear interacts with the stop in a second direction, rotation of the planetary drive is halted in the second direction, opposite the first direction, preventing further rotation of the planetary drive in the second direction.
